(19) United States
(12) Patent Application Publication
(10) Pub. No.: US 2005/0280701 A1
(43) Pub. Date: Dec. 22, 2005

(54) Method and system for associating positional audio to positional video

(76) Inventor: Patrick J. Wardell, Meadow Vista, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/867,484

(22) Filed: Jun. 14, 2004

(51) Int. Cl. H04N 7/14

(52) U.S. Cl. 348/14.08

(57) ABSTRACT

A teleconferencing system and method for producing an audio view at a remote site wherein the audio view is perceptually adapted to at least one video view of a local site. The teleconferencing system includes a camera system configured to generate at a local site an imaging view of an environment around the camera system for transmission to a remote site. A positional audio system coupled to the camera system produces an audio view from audio data at the remote site that is perceptually adapted to the video view at the local site. The audio data is transmitted as monaural audio data from the local to remote sites.

### BACKGROUND OF THE INVENTION

1. Field of the Invention

The invention relates to teleconferencing and, more particularly, to directional audio in a teleconferencing environment.

2. State of the Art

Traditionally, meeting participants had to physically be present at the conference in order to participate in the meeting. But, as society became more mobile, designers developed methods and systems which allowed remote participants to interact in meetings generally via a telephone or telephone-like connection from remote locations using microphones and speakers located at both the main meeting location or local site and the remote meeting location or remote site. With this type of system, the audio signals were sent back and forth between the local and remote sites. These systems worked quite well for audio or sound information; however, if something in the meeting needed to be shown or visualized in the meeting, the remote participants were unable to take part in the visual aspects of the meeting.

As a result of this visual limitation, designers developed video teleconference systems which allowed remote meeting participants to both see and hear the topics of the main meeting using video cameras, microphones and video displays at both the local and remote sites. While these systems were adequate for a simple audio-dominant conversation, problems arose in which the remote participant could not see all of the participants at the main or local meeting, or they would only see the back of the meeting participants if people were located around a table and there was just one camera. Therefore, systems were developed having multiple cameras which could provide different views of the main meeting room. These systems increased the complexity of the teleconference system which increased costs and chances for complications. In addition, the remote participants could view some areas of the main meeting better than other areas, depending on the location of the cameras.

Another method was developed which used a remote controlled camera allowing the remote participant to zoom or pan in on areas of the main meeting room and turn the camera to a desired viewing area. However, these cameras proved to be somewhat limiting for multiple remote participants in addition to being noisy and distracting to the main meeting participants.

To alleviate such problems, designers developed 360 degree video cameras to be placed near the middle of a table which was generally surrounded by the main meeting participants. These cameras captured the image of a full 360° view around the camera. This full view image was then processed through computer software which allowed the remote participant to view the full 360° view around the table, or to zoom in on one location or person at the main meeting. The advantage of the 360° camera is that it stays generally motionless in the middle of the main meeting table causing less distraction to the main meeting participants. With a 360° camera, the remote participants then view the main meeting as if they are located where the camera is located, i.e. in the middle of the main meeting table. The sound for the meeting is generally gathered with a microphone located near the camera near the middle of the table which uses only a monaural or non-directional audio channel. The audio and the video are then transmitted to the remote participant via a telephone line or other type of communication device.

If the remote participant using a 360° camera pans or zooms in on one location or one main meeting participant, the remote participant gets a better or larger view of that part of the room or that participant, but no longer sees the entire room. Then, if a participant located in another part of the main meeting room speaks, the remote participant does not know where that sound is coming from and must pan their view around the room until they find a view of the speaking participant. This leaves that remote participant guessing to find the location of the new speaker. It is therefore desirable to have a system that allows the remote participant have an enhanced audio experience when hearing the audio generated at the main meeting room.

### BRIEF SUMMARY OF THE INVENTION

The present invention is directed to methods and systems for producing an audio view at a remote site wherein the audio view is perceptually adapted to at least one video view of a local site. In one embodiment of the present invention, a teleconferencing system is described. The teleconferencing system includes a camera system configured to generate at a local site an imaging view of an environment around the camera system for transmission to a remote site. The teleconferencing system further includes a positional audio system coupled to the camera system and configured to produce an audio view from audio data at the remote site that is perceptually adapted to the video view at the local site.

In another embodiment of the present invention, a positional audio system is provided for producing an audio view at a remote site that is perceptually adapted to a video view of a local site. The positional audio system includes a local computer configure for coupling with a camera system that is capable of generating, at a local site, an imaging view of an environment around the camera system for transmission to a remote site. The local computer is further configured to generate and send data including monaural audio data for producing an audio view at the remote site that is perceptually adapted to the video view of the local site. The positional audio system further includes a remote computer configured for receiving the data from the local computer and producing the audio view from the monaural audio data.

In yet another embodiment of the present invention, a method for producing an audio view at a remote site perceptually adapted to at least one video view of a local site is provided. Data including monaural audio data is sent from a local computer at the local site to a remote computer at the remote site. The monaural audio data corresponds to at least one imaging view of an environment around a camera system at the local site. At the remote site, an audio view is produced from the data perceptually adapted to the at least one view of the local site.

### BRIEF DESCRIPTION OF THE SEVERAL VIEWS OF THE DRAWINGS

The accompanying drawings, which are incorporated in and constitute a part of the specification, illustrate what are currently considered to be best modes for carrying out the invention:

FIG. 1 is a perspective view of a conferencing environment, in accordance with an embodiment of the present invention;

FIG. 2 is a perspective view of a remote conferencing system, in accordance with an embodiment of the present invention;

FIG. 3A illustrates an active local conferencing system, in accordance with an embodiment of the present invention;

FIG. 3B illustrates an active remote conferencing system, in accordance with an embodiment of the present invention;

FIG. 4 is a block diagram of a conferencing system, in accordance with an embodiment of the present invention;

FIG. 5A illustrates a top view of a camera system, in accordance with an embodiment of the present invention;

FIG. 5B illustrates a side view of a camera system, in accordance with an embodiment of the present invention; and

FIG. 6 is a flow chart of a process for perceptually adjusting audio in response to a video perspective, in accordance with one embodiment of the invention.

### DETAILED DESCRIPTION OF THE INVENTION

The present invention relates to an audio/video teleconferencing device which creates positional audio associated to 360° video, the related software, connectivity, and a method of creating the same. In other words, the invention makes it possible for a remotely located meeting participant user to perceive to hear sounds in a meeting room appropriately as if they are actually in the meeting. That is, when a user changes his or her viewpoint in the meeting room using a 360° video camera, not only will what he or she sees be modified to reflect that change in viewpoint, but what he or she hears will also be modified to reflect a corresponding change in “listening point.”

An exemplary embodiment of the invention is an audio/video teleconferencing device which uses a 360° video camera system and two or more directional audio input devices, such as directional microphones. The camera and the microphones are connected to a local computer system.

The local computer system is a computing device configured to receive audio and video signals. The local computing system may also be integrated with an audio mixing device. The local computer receives the audio signals from the microphones and calculates a perceived audio source direction relative to the viewpoint that the remote meeting participant user is viewing. The local computer calculates the location of input sound by measuring the strength of signal from each of the microphones. The local computer will then package an Absolute Audio Source designator and then transmit this encoded audio data or “package” to another computer, namely a remote computer.

The remote computer is a computing device configured to receive a package of audio/video data from the local computer. The remote computer will then output the decoded audio signal to one or more audio transducer devices with each device having at least two channels for audio. Using multi-dimensional audio software, this output sound will then give the remote participant the perception that the audio sound is coming from the location in the meeting room where it would come from if the remote participant was attending the meeting and setting in the place of the 360° camera.

Embodiments of the present invention find application to providing audio that has been perspectively modified according to a specific video view currently selected by a user. The audio aspects of the present invention may be used in conjunction with video cameras that provide a full 360° video view with selectable perspectives. By way of example and not limitation, exemplary video cameras include panorama video cameras from Be Here Technologies of Fremont, Calif., as well as other compatible and related panoramic video cameras and associated computer software which allows viewers to, in effect, “move around the room,” by changing their viewpoint within the room. While such video cameras generally remain stationary, a remote participant or viewer can select to see one or more portions of the panoramic view from among the full 360° image around the camera.

While the user in a panoramic video conference may select a video image with which to align or orient themselves, the one or more various embodiments of the present invention enable the user to also experience the audio in an oriented manner as well. For example, the embodiments of the present invention make it possible for the user to hear sounds spatially or directionally corrected as oriented to their particular video perspective of the local room or environment about the camera system. In accordance with the present invention, when the remote participant changes their viewpoint at the local site, not only will the video perspective be modified to reflect that change in viewpoint, but the audio perspective will also be modified to reflect a corresponding change in “listening point.” By linking the sound and the view, confusion may be reduced making it easier for the remote participant to follow discussions or other events taking place at the local site.

In accordance with an embodiment of the present invention, sound is input into the system with multiple sound input devices, such as microphones, located near the 360° camera and then played back through multiple speakers, an example of which may include a headset, at a remote participant's location. The playback may be controlled through a combination of hardware and software, and may use network connectivity between the main meeting location and one or more remote location. The spatially adjusted audio in conjunction with the panoramic video of the meeting room, provided by a 360° video camera system, creates a perceptually more accurate conferencing experience for the user.

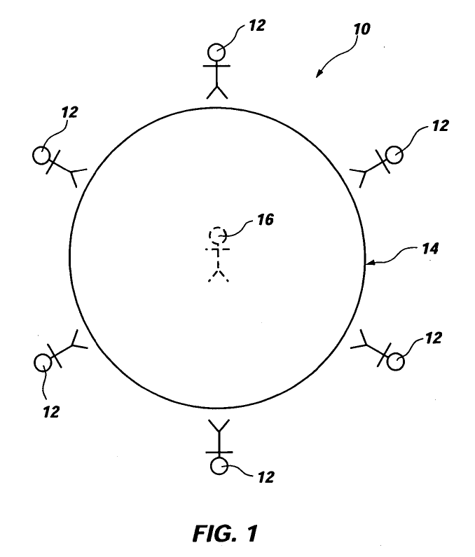

FIG. 1 is an illustrative conferencing arrangement wherein a teleconference arrangement 10 at a local site which includes local participants 12 distributed around an area, for example, around a table 14. When additional participants, such as remote participants 16, are not actually located in the meeting room, they need a “perspective” from which to appear to view the local proceedings. Various embodiments of the present invention allow the remote participants 16 to have the perception that they are attending the meeting. While views and locations from which to view the meeting are essentially infinite, one desired perspective location includes a point generally central to the various local participants 12. In order to facilitate such a perspective, a system may be placed at various locations, such as near the center of the gathered local participants 12 and is herein illustrated as local participants 12 surrounding, for example, a table 14, to provide one desired perception to remote participants 16. From this central vantage point generally near the center of the table 14, the video and audio perspective is also outward from the center of the table. Because of a generally central location of the perspective for the remote participants 16, each one of the one or more remote participants 16 may each reorient themselves to have a different viewing point.

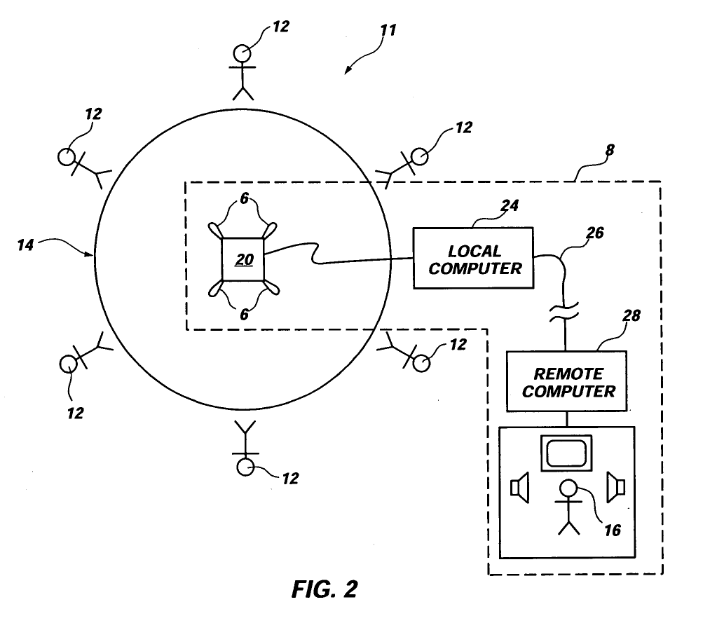

FIG. 2 is a perspective view of a teleconference arrangement for coupling remote participants with local participants, in accordance with an embodiment of the present invention. In a teleconferencing arrangement 11, the local participants 12 and the remote participants 16 conduct a teleconferencing session utilizing a teleconferencing system 8. The local participants 12 surround a 360° video or panoramic camera system 20 which, as previously stated, may be located anywhere about the local participants 12, and is preferably located central to the local participants 12, such as near the center of the table 14.

In one embodiment of the present invention, the camera system 20 generates video and audio data for remote transmission. An Absolute Audio Source designator corresponding to an audio source direction as oriented to the selected viewing perspective or angle as referenced to the camera system 20, is associated with the audio data transmitted to each remote participant. The teleconferencing system 8 further includes a local computing device 24 for calculating the location of each sound based on the relative signal strength at each sound input device 6. The actual direction of the source of the audio, the Absolute Audio Source designator, is determined in relation to the static orientation of the camera assembly system 20 within the local meeting room. The local computer 24 sends a panoramic view to all remote users while the remote computer 28 formats the view into a piece of the panoramic view. By sending only the panoramic view, network traffic is reduced and only one video data stream needs to be sent to all remote users. Because only one data stream is sent, multi-cast may be used to send the video transmission thereby allowing potentially thousands of people to see and control the viewing and audio location. In one embodiment of the present invention, one video stream, audio stream and absolute audio position packets are sent to all remote users resulting in minimum network bandwidth usage and maximum remote user experience. The local computer 24 calculates the Absolute Audio Source designator and forms a perceived audio source directional packet for transmission with the audio data. At the remote location, the received Absolute Audio Source designator is used in conjunction with the remote participant selected viewpoint specified by the Absolute Video Location designator to derive a Perceived Audio Source designator for directionally exciting the audio speaker arrangement about the remote participant to create a panoramic audio experience for the remote participant. The Perceived Audio Source designator is the difference of the Absolute Audio Source designator minus the Absolute Video Location designator. The perceived audio source orients the perceived direction of the audio data relative to the video viewpoint as selected by the remote participant.

The local computer 24 may be integrated together or interfaced with the remote participants via any number of data communication methods such as RS232, LAN, or etc. The local computer 24 calculates the absolute location of the sound and generates an Absolute Audio Source designator identifying an absolute audio source location as oriented to the camera system 20 at the local site. The local computer 24 transmits a packet including the Absolute Audio Source designation and monaural audio data to the remote computer 28. The local computer 24 and the remote computer 28 may be coupled via telephone, Internet or similar type of connection or connectionless interface 26. Upon receipt of the packet, the remote computer 28 translates the audio data into perceived audio data at the remote location by calculating the Perceived Audio Source designator from the difference between the received Absolute Audio Source designator as determined by the local computer 24 and the Absolute Video Location designator as generated by the remote computer 28 when requesting video data for a specific video viewpoint from the camera system 20 at the local site. The remote computer 28 may also process the received monaural audio data using a processor and outputs the audio signal to one or more audio devices as adjusted in perception according to the calculated Perceived Audio Source designator. The audio data undergoes perspective translation based upon the calculated Perceived Audio Source designator using, for example, three-dimensional positional audio technology, (e.g., Qsound™ available from QSound Labs, Inc. of Calgary Alberta, Canada, or Sensaura™ available from Sensaura Ltd. of Hayes Middlesex, England). The received audio data is from monaural to multi-aural according to the formula: Perceived Audio Source=Absolute Audio Source−Absolute Video Location, and applying the result to the three-dimensional positional audio processing of remote computer 28. The perceived audio data the remote participant hears allows the remote participant to alter their Absolute Video Location designator in the direction of the calculated Perceived Audio Source. Once the Perceived Audio Source designator and the Absolute Video Location designator are the same (Perceived Audio Source=Absolute Audio Source−Absolute Video Location), the remote participant 16, in their current view, would be looking at the Absolute Audio Source at the local site.

In accordance with an embodiment of the present invention, each remote participant 16 hears the audio data relative to the direction they are looking, calculated from the same Absolute Audio Source designator sent with the one or more packets of audio data. This method allows the use of a single monaural audio stream sent to all of the remote participants 16 saving bandwidth and simplifying processing on the remote participant's computer 28. By using positional video and a monaural audio stream, a telephone line may be used as the audio transport instead of Voice over Internet Protocol, VoIP. Alternatively, the audio and video may be sent via an Internet audio/video routing system such as, but not limited to, unicasting or multicasting, according to well known networking protocols.

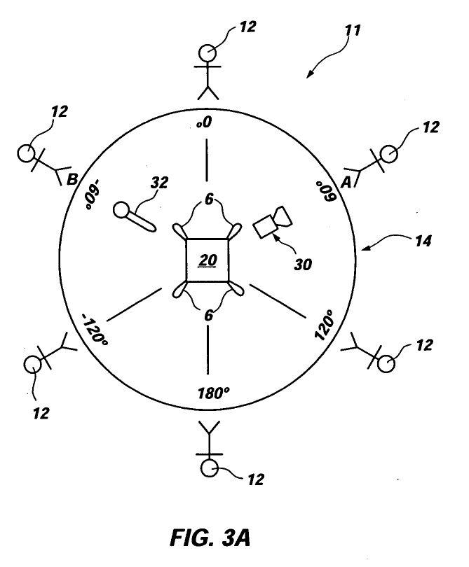

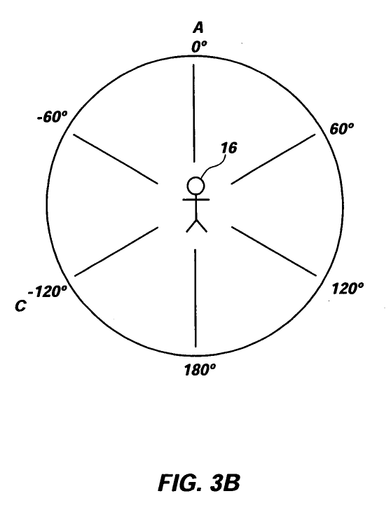

FIGS. 3A and 3B illustrate an exemplary arrangement of the local and remote teleconferencing arrangement, respectively, in accordance with an embodiment of the present invention. In a portion of teleconference arrangement 11, the local meeting participants 12 surround, for example, a table 14 in view of a camera system 20. FIG. 3A illustrates the local meeting participants 12, by way of example and not limitation, in relative locations, (−60°, −120°, etc.) from a 0° absolute reference point. Orientation of the camera system 20 allows a remote participant 16 (FIG. 3B) to view various perspective angles which may include the entire 360° panorama of the room or surroundings. Each remote participant 16 may select through an Absolute Video Location designator a unique view of the meeting room or may share the same view with another remote participant. The view from the camera system 20 is viewed from the location of the camera, e.g., the middle of the table 14. So, for example, a particular remote participant 16 may view local meeting participant 12 in location A which is 60° from the absolute reference point of 0°, as shown in FIG. 3A. Therefore, the view of the remote participant 16 is perceptually like a figurative camera 30 is pointed toward the location A from the middle of the table 14.

While the present example illustrates the remote participant 16 viewing in the direction A, which is exemplary set with the Absolute Video Location designator of 60° from the absolute reference point of 0°, the remote participant perceived video location remains at a perspective of 0° as shown in FIG. 3B. The audio data gathered by the camera system 20 may be processed by an audio mixer or other audio processing method within local computer 24 to determine the location, designated by the Absolute Audio Source designator, of the sound coming into a multiplicity of directional audio input devices, such as but not limited to microphones. The directionality of the audio data, in one embodiment, is measured from the relative strength of the audio signals received by each of a multiplicity of audio input devices 6. If the local participant 12, located in position A, is speaking within the teleconference arrangement 11, then the remote meeting participant 16 will perceive the sound (i.e. perceived audio source) as coming from directly in front. The formula for calculating Perceived Audio Location becomes:
(Perceived Audio Location(C)=Absolute Audio Source(B)−Absolute Video Location (A)).

In order for the remote participant 16 to perceive directionality in the audio, the teleconferencing system utilizes at least two audio channels coupled to, for example, stereo headphones, ear buds, surround-sound speaker systems or the like, to give the perception that the sound is coming from a specific direction. Multiple remote participants 16 can each view different locations at the same time and therefore, each remote participant 16 senses a different audio position experience depending on the selected video direction or viewpoint.

By way of example with reference to FIGS. 3A and 3B, if the remote participant 16 is participating within the teleconference arrangement 11 at a remote location, and the remote participant is viewing in the direction of A, and a local participant 12 in location B speaks, remote participant 16 (FIG. 2) will perceive an audio source location calculated according to (Perceived Audio Source (C)=Absolute Audio Source (B)−Absolute Video Location (A)) or (−120°=−60°−60°).

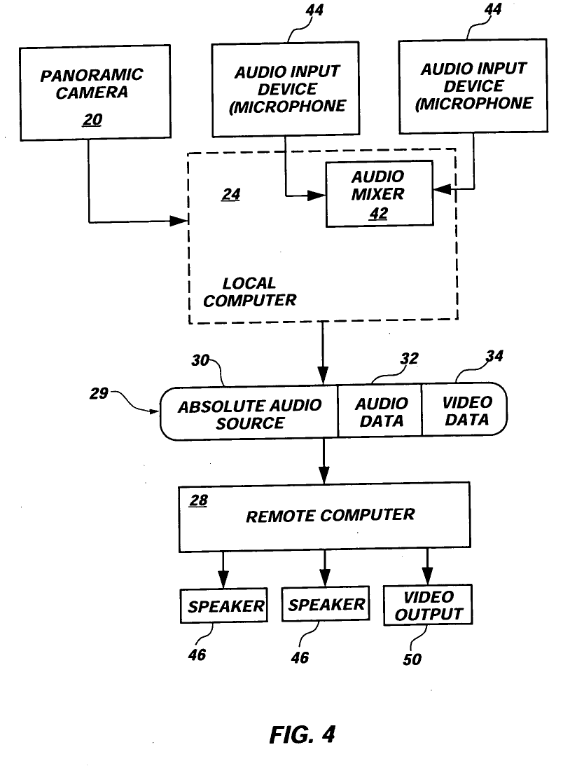

FIG. 4 is a block diagram of the teleconferencing system, in accordance with an embodiment of the present invention. As stated, the teleconferencing system 8 (FIG. 2) includes a panoramic camera system 20 generally set in a central location to the local participants 12 (FIG. 2). The camera system 20 electrically and operably connects to a local computer 24 which receives video data from the camera system 20. The teleconferencing system 8 further includes a positional audio system configured to perceptually present audio from the local site to a remote participant with a perceptual orientation of the audio data consistent with the selected imaging viewpoint of the local participants as perceived by the remote participant. Local computer 24 sends a panoramic view to all remote users. A program within remote computer 28 formats the view into a piece of the panoramic view. By sending only the panoramic view, reduced network traffic may be realized and only one video data stream needs to be sent to all users. Because only one data stream is sent, multi-cast may be used to send the video transmission allowing potentially thousands of people to see and control the viewing and audio location.

The teleconferencing system 8 further includes at least two directional audio input devices 44, an example of which includes microphones, electrically connected to an audio processor such as an audio mixer 42. The audio mixer 42 and the local computer 24 may be collocated within the same physical or functional device. If the local computer 24 and the audio mixer 42 are not coupled via a direct bus, they may be coupled using one or more external connections such as through an RS 232, LAN, or similar type connection. The local computer 24 is further coupled to the remote computer 28 to transmit the audio/video data 32, 34 to the remote computer 28. The transmitted data further includes an Absolute Audio Source designator 30. The remote computer 28 decodes the received video data 34 and outputs the video to one or more electrically connected video devices 50. The audio data 32 is processed from monaural data into multi-aural or directional audio data presenting a perceived origin of the audio data according to the processes previously described. The positional audio data is then presented to one or more audio sound devices 46. The audio data 32 sent to the remote computer 28 is a monaural audio stream resulting in a reduced amount of network bandwidth needed to listen to the audio remotely. A single packet 29 of data containing the Absolute Audio Source designator 30 is sent to the remote participants 16, in one embodiment with each audio position change, or in another embodiment, the designator may be sent multiple times per time interval. The relative position of the audio as perceived by the remote participant 16 is calculated from the Absolute Audio Source designator and the Absolute Video Location designator. This allows the same monaural audio stream to be sent to all remote participants 16 instead of a different stream being processed for each remote participant 16 thereby reducing network traffic and processing power. Embodiments of the present invention may also be used according to audio, video and absolute audio position packet multicasting, as understood by those of ordinary skill in the art, thereby further reducing bandwidth requirements.

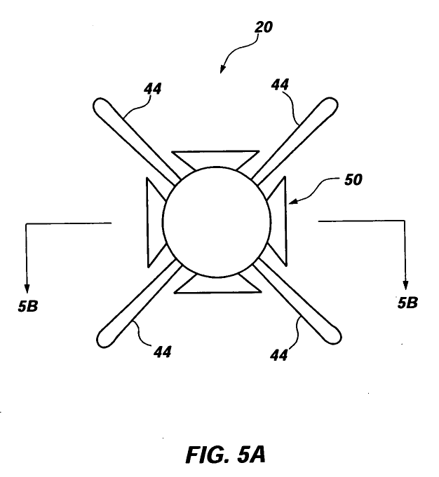

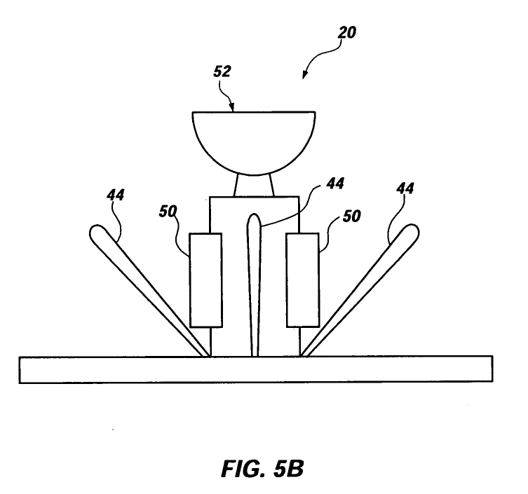

FIGS. 5A and 5B illustrate an exemplary embodiment of a camera system 20, in accordance with an embodiment of the present invention. The camera system 20 may be configured to display a panoramic view around a room using a parabolic type lens 52, examples of which are available from manufactures as identified herein above. The camera system 20 further includes audio input devices, illustrated herein as four audio input devices 44, an example of which includes but is not limited to shotgun microphones or the like. The audio input devices 44 may have a 90° sound pick-up field, but up to a 180° pick-up field device can be used if only two such audio input devices 44 are used. The audio input devices 44 are exemplary placed at equal distances from one another. An exemplary embodiment of the invention uses a plurality (>2) of directional audio input devices 44 to determine location of sound around the camera system 20 for generation of monaural audio data 32 (FIG. 4) and for further use in generating an Absolute Audio Source designator 30 (FIG. 4) for identifying the originating direction of the audio data. By way of example, FIG. 5A illustrates four microphones placed equal distances apart and at right angles to each other.

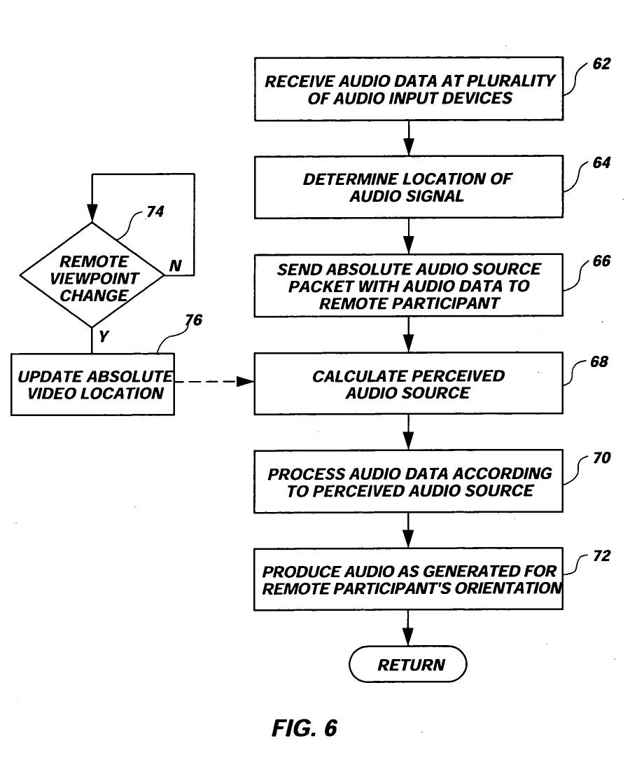

FIG. 6 is a flowchart of a method for generating positional audio, in accordance with an embodiment of the present invention. Audio data generated by a local participant 12 (FIG. 2) is received 62 by at least two audio input devices 44 (FIG. 4). An audio process such as an audio mixer 42 (FIG. 4) evaluates the relative audio signals as received at each of the audio input devices 44 and determines 64 an Absolute Audio Source designator based upon one or more audio directional techniques, including but not limited to comparative analysis of signal strengths at each of the audio input devices 44. Other directional analysis techniques are also contemplated including phase shift analysis and other signal processing and analysis techniques.

A local computer 24 associates the Absolute Audio Source designator 30 with the corresponding monaural audio data 32 (FIG. 4) for sending 66 to a remote participant at a remote site via a remote computer 28 (FIG. 4). The audio data 32 and Absolute Audio Source designator 30 may be further accompanied over the same network by the corresponding video data 34 or, alternatively, the video data may be transmitted over a higher bandwidth channel between the local participants and the remote participants.

The audio data 32 (FIG. 4) and Absolute Audio Source designator 30 (FIG. 4) are received by a remote computer 28 (FIG. 4) at a remote participant site. The remote computer 28 (FIG. 4) calculates 68 a Perceived Audio Source designator as the difference between the Absolute Audio Source designator less the Absolute Video Location designator. A directional process within remote computer 28 (FIG. 4) processes 70 the audio data 32 (FIG. 4) according to the calculated Perceived Audio Source. The processed audio data is output 72 to sound devices 46 (FIG. 4) at the remote participants location.

If the remote participant selects 74 a change in viewpoint from the camera system 20 (FIG. 4), then the Absolute Video Location designator is updated 76 within the remote computer 28 and a request containing the Absolute Video Location designator is sent from the remote computer 28 to the local computer 24 to alter, according to the Absolute Video Location designator, the viewpoint and hence the video data 34 (FIG. 4) sent to the change-requesting remote computer 28.

While the invention may be susceptible to various modifications and alternative forms, specific embodiments have been shown by way of example in the drawings and have been described in detail herein. However, it should be understood that the invention is not intended to be limited to the particular forms disclosed. Rather, the invention includes all modifications, equivalents, and alternatives falling within the spirit and scope of the invention as defined by the following appended claims.

1. A teleconferencing system, comprising:
a camera system configured to generate at a local site at least one imaging view of an environment around said camera system for transmission to a remote site; and
a positional audio system operably coupled to said camera system, said positional audio system configured to produce an audio view from audio data at said remote site perceptually adapted to said at least one video view of said local site.

2. The teleconferencing system of claim 1, wherein said positional audio system comprises a local computer configured to determine an absolute audio source designator indicating an originating direction of said audio data about said camera system.

3. The teleconferencing system of claim 2, wherein said local computer further comprises an audio mixer coupled to a plurality of audio input devices, said audio mixer configured to derive said absolute audio source designator from audio differences received at said plurality of audio input devices of said audio data.

4. The teleconferencing system of claim 2, wherein said local computer is further configured to associate said absolute audio source designator with said audio data.

5. The teleconferencing system of claim 2, wherein said audio data is configured as monaural audio data.

6. The teleconferencing system of claim 2, wherein said positional audio system comprises a remote computer configured for operably coupling with said local computer, said remote computer configured to produce said audio view of said at least one video view.

7. The teleconferencing system of claim 6, wherein said remote computer is further configured to generate said audio view from said absolute audio source designator and said audio data configured as monaural audio data.

8. A positional audio system, comprising:
a local computer configured for coupling with a camera system capable of generating at a local site at least one imaging view of an environment around said camera system for transmission to a remote site, said local computer further configured to generate and send data including monaural audio data for producing an audio view at said remote site perceptually adapted to said at least one video view of said local site; and
a remote computer configured for receiving said data from said local computer and to produce said audio view from said monaural audio data of said at least one video view at said remote site.

9. The positional audio system of claim 8, wherein local computer is further configured to determine and send as part of said data an absolute audio source designator indicating an originating direction of said monaural audio data about said camera system.

10. The positional audio system of claim 9, wherein said remote computer is configured to generate and send to said local computer an absolute video location designator for selecting said at least one imaging view from among a plurality of imaging views of said camera system.

11. The positional audio system of claim 10, wherein said remote computer is further configured to generate said audio view from said absolute audio source designator and said monaural audio data.

12. The positional audio system of claim 9, wherein said local computer further comprises an audio mixer coupled to a plurality of audio input devices, said audio mixer configured to derive said absolute audio source designator from audio differences received at said plurality of audio input devices of said monaural audio data.

13. A method for producing an audio view at a remote site perceptually adapted to at least one video view of a local site, comprising:
sending data including monaural audio data from a local computer at said local site to a remote computer at said remote site, said monaural audio data corresponding to at least one imaging view of an environment around a camera system at said local site; and
producing at said remote site an audio view from said data perceptually adapted to said at least one view of said local site.

14. The method of claim 13, further comprising determining as part of said data an absolute audio source designator indicating an originating direction of said monaural audio data about said camera system.

15. The method of claim 14, further comprising generating said audio view from said absolute audio source designator and said monaural audio data.

16. The method of claim 15, wherein said generating said audio view from a difference between said absolute audio source designator and said absolute video location designator oriented to said camera system.

17. The method of claim 13, further comprising receiving audio data from a plurality of audio input devices and deriving said absolute audio source designator from audio differences of said monaural audio data received at said plurality of audio input devices.

18. The method of claim 14, further comprising updating said absolute audio source designator when said absolute video location designator changes.

19. A positional audio system, comprising:
a means for coupling with a camera system capable of generating at a local site at least one imaging view of an environment around said camera system for transmission to a remote site;
a means for generating and sending data including monaural audio data for producing an audio view at said remote site perceptually adapted to said at least one video view of said local site;
a means for receiving said data from said local computer; and
a means for producing said audio view from said monaural audio data of said at least one video view at said remote site.

20. The system of claim 19 wherein said local computer further comprises a means for determining and sending as part of said data an absolute audio source designator indicating an originating direction of said monaural audio data about said camera system.
